(19) United States
(12) Patent Application Publication
(10) Pub. No.: US 2015/0217146 A1
(43) Pub. Date: Aug. 6, 2015

(54) RESPIRATOR MASK COMPRISING A BAYONET CLOSURE FOR A FILTER MODULE

(71) Applicant: MOLDEX-METRIC, INC., CULVER CITY, CA (US)

(72) Inventors: TORBEN SKOV, PLlEZHAUSEN (DE); THIEL DIETMAR, PLlEZHAUSEN (DE)

(73) Assignee: MOLDEX-METRIC, INC.

(21) Appl. No.: 14/605,768

(22) Filed: Jan. 26, 2015

(30) Foreign Application Priority Data
Feb. 6, 2014 (DE) 102014001938.1

(51) Int. Cl. A62B 23/02; A62B 18/08; A62B 18/10; A62B 18/02

(52) U.S. Cl. CPC A62B 23/025; A62B 18/02; A62B 18/084; A62B 18/10

(57) ABSTRACT

The invention relates to a respirator mask comprising a mask body for covering mouth and nose of a user, comprising at least one exhalation valve and least one inhalation valve arranged at the mask body, and in each case comprising a filter module, which is assigned to the inhalation valve and which is/can be detachably fastened to the mask body. The mask body encompasses an opening, through which a housing part of the inhalation valve reaches, wherein the housing part, together with the filter module, forms a detachable bayonet closure. The housing part is rotatably supported in the opening of the mask body and for the opening to be embodied in a bottom of an accommodating recess of the mask body, which encompasses a contour, which differs from a circle, for accommodating the filter module so as to be locked against rotation.

This application is based on and claims the benefit of priority from the German Patent Application No. 102014001938A filed on Feb. 6, 2014, the contents of which are incorporated by reference.

The invention relates to a respirator mask, comprising a mask body for covering mouth and nose of a user, comprising at least one exhalation valve arranged at the mask body, comprising at least one inhalation valve arranged at the mask body, and in each case comprising a filter module, which is assigned to the inhalation valve and which is/can be detachably fastened to the mask body, wherein the mask body encompasses an opening, through which a housing part of the inhalation valve reaches, and wherein the housing part, together with the filter module, forms a detachable bayonet closure.

### STATE OF THE ART

Respirator masks of the above-mentioned type are known from the state of the art. They serve the purpose of protecting a user from air contaminants. By means of a mask body, which can be arranged over mouth and nose of a user, a closed head space, which is separated from the environment, is formed for the user. A gas or air exchange, respectively, can then take place between the user and the environment through the mask body with the help of at least one exhalation valve and at least one inhalation valve, both of which are arranged at the mask body. To ensure the purity of the inhaled air for the user, a filter module, through which the air must preferably flow before it reaches the inhalation valve, is assigned to the inhalation valve. To be able to use the respirator mask for a long period of time, it is necessary for the filter module(s) to be capable of being replaced, if necessary. Various solutions are already known with regard to this.

For example, U.S. Pat. No. 5,222,488 thus discloses a filter module, which can be screwed to the mask body. A respirator mask, in the case of which the filter module can be connected to the mask body by means of a bayonet closure, furthermore follows from U.S. Pat. No. 4,934,361, Provision is thereby made for a housing part of the inhalation valve to permeate an opening of the mask body and to be held on the mask body in a torque-proof manner. The filter module can then be attached to the housing part from the outside and can be rotated, so as to close the bayonet closure. A simple and reliable fastening of the filter module to the mask body is ensured through this. However, it is disadvantageous hereby that the mask body must be embodied such that a rotation of the filter module is always possible at the mask body. As a result, the form of the filter module and of the mask body, as shown in U.S. Pat. No. 4,934,361, is substantially determined by means of its function. In addition, there is a risk that a user detaches the bayonet closure during operation, for example, because he wants to clean a vision protection for the user's eyes, which leads to the detachment of the bayonet closure.

The invention is thus based on the task of creating a respirator mask, which avoids the above-described disadvantages in a simple and cost-efficient manner.

The task on which the invention is based is solved by means of a respirator mask comprising the features described herein. Said respirator mask has the advantage that an inadvertent detaching of the bayonet closure is avoided in a simple manner and that, at the same time, the optical design freedom for the respirator mask is increased, wherein the detaching and fastening of the filter module from and to the mask body is possible without increased effort. The respirator mask according to the invention is characterized in that the housing part is rotatably supported in the opening of the mask body and that the opening is embodied in a bottom of an accommodating recess of the mask body, which encompasses a form, which differs from a circle, for accommodating the filter module so as to be locked against rotation. The invention thus provides for the filter module to be capable of being inserted into an accommodating recess of the mask body. The contour of the accommodating recess differs from a circle, so that it forms a form-locking protection for the filter module against rotation, which advantageously also encompasses an outer contour, which differs from a circular form. If the filter module is inserted into the accommodating recess, it cannot be rotated any longer. The bayonet closure is then closed or detached, in that the housing part, which reaches through the opening of the mask body and which is rotatably supported in the opening, is rotated. If the user wants to replace the filter module, he only needs to rotate the housing part in the correct direction in order to open the bayonet closure, to remove the old filter module from the accommodating recess, and to insert anew filter module into the accommodating recess and to rotate the housing part back. Even though the user needs to take off the respirator mask for this purpose, this does not result in a disadvantage, because the user would not perform the replacement of the filter module in an environment, in which he is dependent on the filter effect, in any event.

According to an advantageous further development of the invention, provision is made for the housing part to encompass a circular-cylindrical base body and, at a front side of the base body, at least one support element for resting against an inner side of the mask body. The housing part thus supports itself on the inner side of the mask body by means of the at least one support element, so that it cannot be pulled out through the opening of the mask body.

Preferably, the support element is embodied as ring disk, the outer diameter of which is larger than the diameter of the opening. Due to the embodiment as ring disk, the support element rests evenly against the inner side of the mask body, whereby the forces, which act on the bayonet closure, are transferred evenly and reliably to the mask body, and it is ensured that the housing part can be rotated easily.

Provision is furthermore made in a preferred manner for the housing part to encompass a plurality of rear grip elements, which are arranged at its outer jacket wall of the base body and which protrude radially and which are embodied to interact with at least one rear grip counter element of the filter module. The rear grip elements and rear grip counter elements thus form the bayonet closure, which can be closed or detached by rotating housing part and filter module relative to one another. In the closed state, the rear grip elements and the at least one rear grip counter element form a form-locking rear grip, which prevents a detachment of the filter module from the housing part and thus from the mask body.

Preferably, the opening in the mask body encompasses a plurality of radial recesses, which serve for the lead-through of the rear grip elements of the housing part. The rear grip elements are thereby arranged at an (axial) distance to the support element or from the ring disk, respectively, so that, due to its outer jacket wall, the housing part is supported in the opening, preferably so as to be substantially free from play as soon as the rear grip elements have penetrated the opening.

Provision is further made in a preferred manner for the filter module to encompass a filter housing, the outer contour of which corresponds at least substantially to the contour of the accommodating recess. Due to the fact that the contours of filter module and accommodating recess at least substantially correspond to one another, the high-quality impression of the respirator mask is increased on the one hand and a particularly reliable and resilient form closure is ensured between filter module and mask body so as to be locked against rotation. In addition, a sealing effect between filter housing and mask body can be reached through this at the circumferential side of the filter module, which increases the reliability of the respirator mask.

According to an advantageous further development of the invention, provision is made for the filter housing to encompass the at least one rear grip counter element, which is embodied as bayonet ring for accommodating the housing part of the inlet valve. The housing part is partially inserted axially into the bayonet ring, wherein the bayonet ring encompasses corresponding radial recesses at least corresponding to the number and arrangement of the rear grip elements, which are provided at the housing part. The rear grip elements can be axially guided through said radial recesses. If the housing part is rotated subsequently, the rear grip elements reach the above-described closed position, in which they engage behind the rear grip elements in a form-locking manner.

Provision is furthermore made in a preferred manner for the bayonet ring to be arranged at a filter module bottom of the filter housing, which encompasses a plurality of flow-through openings. While, on principle, provision can be made according to a first embodiment for the filter module to only encompass one opening for the inhalation air in its filter module bottom, whereby said opening is advantageously arranged in the area of the bayonet ring for fluidic connection to the inlet valve, provision is made according to this preferred embodiment for the filter module bottom to encompass a plurality of flow openings, which are in particular also provided outside of the bayonet ring. The counter pressure, which is created by means of the filter module, is thus kept low as a whole when inhaling, so that breathing is particularly easy for a user. As described above, the sealing effect, which is to prevent a mixing of the filtered air with unfiltered air, can be ensured by adapting the contours of filter module and accommodating recess.

According to a preferred further development of the invention, provision is made for the filter module bottom and/or the accommodating recess to encompass in each case at least one sealing web, which runs in a frame-like manner at a distance to the bayonet closure. Due to the frame-like course, the sealing web is embodied so as to be continuous, thus without gaps and surrounds the bayonet closure. The sealing web is thereby embodied such that, in the closed state of the bayonet closure, it rests against the filter module bottom and/or against the bottom of the accommodating recess in a sealing manner. In a particularly preferred manner, the sealing web is embodied so as to be at least partially elastically deformable. The sealing web thus furthermore also provides a spring force, which is used to reliably close the bayonet closure.

The sealing web thereby preferably extends parallel to the outer contour of the respective accommodating recess. In the alternative, the sealing web can also encompass a form, which is independent from or which differs from the outer contour, respectively. For example, the sealing web can extend around the inlet valve in a circular ring-shaped manner. In particular, provision can thereby be made for the sealing web to always be arranged at a distance to the side walls of the respective accommodating recess. It is also possible for the ring shape of the sealing web to not be embodied so as to be circular, but, for example, polygonal, for example square or rectangular or also in a star-shaped manner.

According to a preferred further development of the invention, provision is made for the flow-through openings in the filter module bottom to only be embodied in an area, which is framed by the sealing web. The air, which is filtered through the filter module, thus only reaches into the area between filter module and accommodation recess, which is limited laterally by the sealing web. The potential of the filter module is optimally utilized through this.

Provision is further made in a preferred manner for at least one recess to be embodied between the bayonet ring and the filter module bottom. The recess between the filter module bottom and the bayonet ring ensures that the air, which reaches through the flow-through openings into the area, which is limited laterally by the sealing web, always reaches the inhalation valve. In the closed state of the bayonet closure, the housing part preferably also encompasses an axial distance to the filter module bottom, so as to provide, for example, for a detachment of the filter module by pressing against the mask body or against the spring force, which is provided by the sealing element, respectively, and for an air flow to the inlet valve. In the alternative, provision is preferably made for the base body to encompass at least one radial recess for the air flow.

Preferably, the rear grip elements and/or the at least one rear grip counter element encompass at least one inclined surface, so as to ensure that the filter module is pressed against the mask body in response to closing the bayonet closure. Due to the inclined surface, it is made possible in response to the rotation of the housing part that the filter module is pulled against the mask body, so that in particular the sealing web is securely tightened between filter module and accommodating recess.

Provision is further made in a preferable manner for the bayonet closure to encompass at least one locking means for detachably holding the bayonet closure in the closed position. The locking means serves the purpose of further increasing the reliability against an unintentional detaching of the bayonet closure in spite of the reliability, which is already high. In particular, latching means are provided as locking means, which are realized, for example, by means of at least one latch protrusion, which is embodied at the filter module or at the mask body, and by means of a latch protrusion accommodation, which is embodied at the mask body or at the filter module, and which interact when in the closed state. By overcoming the latch connection by accordingly applying a high torque to the housing part, said latch protrusion accommodation can be detached in a simple manner. The latch connection is preferably assigned to the bayonet closure.

According to a preferred further development of the invention, provision is made for the mask body to be embodied in multiple parts, comprising a mask base body and comprising at least one cup element, which forms the respective accommodating recess, wherein the cup element preferably encompasses a higher stiffness than the mask base body.

Due to the multi-part embodiment, the production of the mask body is simplified. In addition, the multi-part embodiment makes it possible for the mask base body and the cup element to encompass different characteristics in particular with reference to their flexibility. Due to the preferred embodiment, according to which the mask base body encompasses a higher flexibility than the cup element, it is ensured that the mask base body adapts comfortably to the facial shape of the user on the one hand and that the cup element ensures a sufficiently high stiffness for securely and tightly connecting the filter module to the mask body.

The invention will be explained in more detail below by means of an exemplary embodiment.

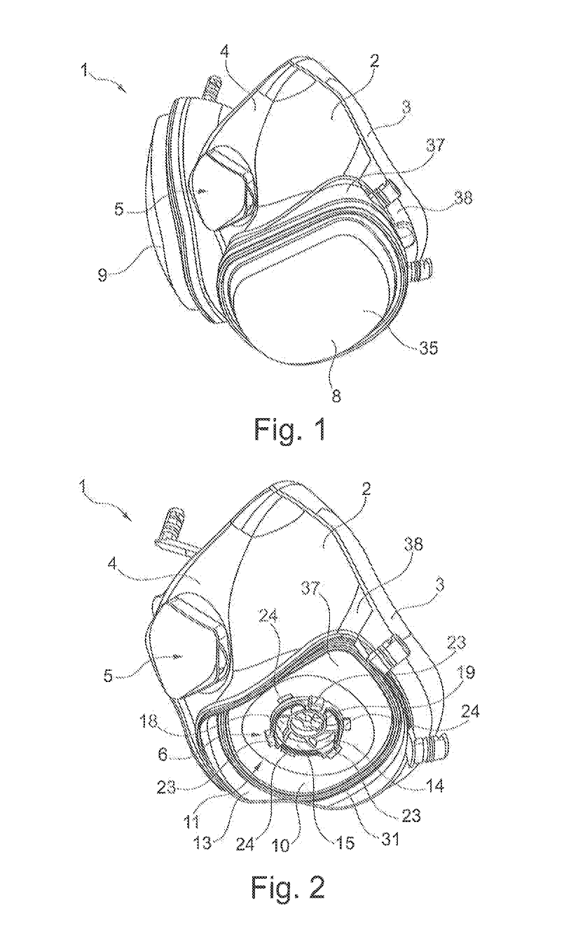

FIG. 1 shows a respirator mask in a perspective illustration,

FIG. 2 shows the respirator mask. with removed filter modules,

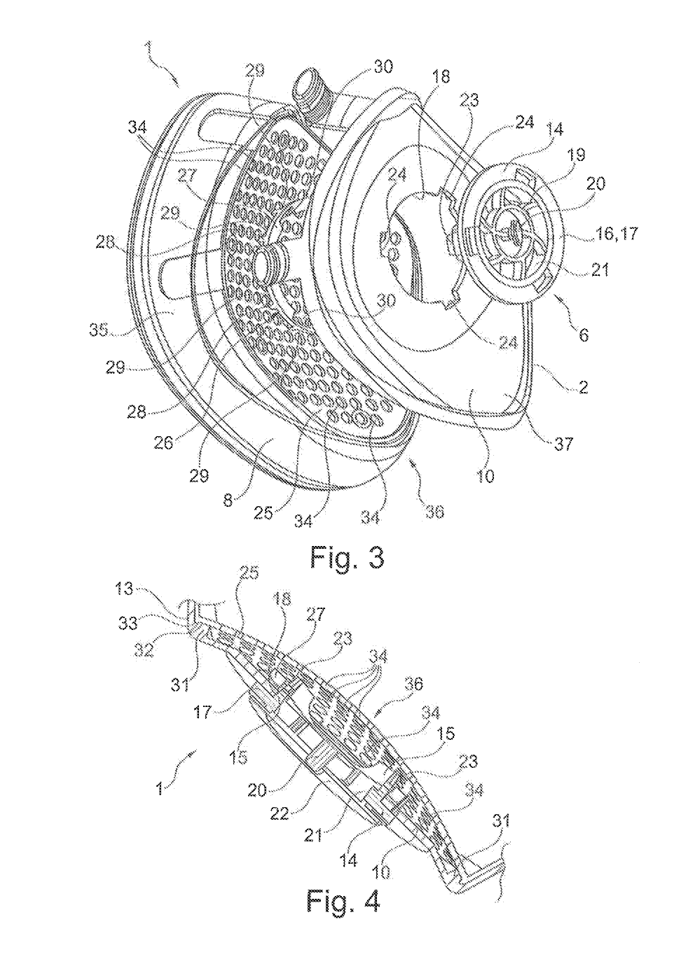

FIG. 3 shows a section of the respirator mask in an exploded illustration and

FIG. 4 shows a sectional illustration of the respirator mask.

In a perspective illustration, FIG. 1 shows a respirator mask 1, which encompasses a mask body 2, which is embodied to separate the nose and the mouth of a user from the environment. For this purpose, the mask body encompasses a flexible sealing lip 3, facing the user. Said sealing lip 3 adapts to the facial shape of the user in a gas-tight manner, when the respirator mask 1 is pressed against the face of the user, for example by means of fastening straps, which engage behind the head of the user and which are fastened to the mask body 2. In the center, the mask body 2 encompasses a curvature 4, which is to be assigned to the nose of the user and which supports an exhalation valve 5. The exhalation valve 5 reaches through the mask body 2 and allows air to escape to the outside from the interior of the respirator mask 1, while it closes in opposite flow direction, so that the user cannot inhale air from the environment through the exhalation valve 5.

For inhalation, provision is made for two inhalation valves 6, 7, which are arranged below the curvature 4 on both sides of the curvature 4, as can be seen from FIG. 2. The respirator mask 1 furthermore encompasses two filter modules 8 and 9, which are in each case assigned to one of the inlet valves 6 and 7 and which can be arranged on the outer side of the respirator mask 1. FIG. 1 thereby shows the respirator mask 1 with the filter modules 8, 9 arranged thereon. FIG. 2 shows the respirator mask 1 without the filter modules 8, 9. The inlet valves 6, 7 are in each case arranged in a bottom 10 of a respective accommodating recess 11, wherein only one of the accommodating recesses 11 can be seen in the case at hand. For this purpose, one opening 18, in which the respective inhalation valve 6, 7 is arranged so as to reach through the mask body 2, is in each case embodied in the bottom 10. The accommodation recesses 11 in each case encompass a contour, which differs from a circle, which, in the instant case, corresponds substantially to a rectangle comprising rounded corners. The bottom 10 is embodied so as to be curved in a plurality of directions, so as to ensure an advantageous wearing comfort of the respirator mask 1. The respective accommodating recess 11 is limited laterally by means of a substantially continuous side wall 13, which defines the contour of the respective accommodating recesses. Advantageously, the respirator mask 1 is embodied in a mirror-inverted manner, so that the accommodating recesses 11 for the filter modules 8, 9 are also embodied so as to be mirror-inverted.

FIG. 3 shows an enlarged exploded illustration of the respirator mask 1, wherein only the section of the filter module 8 is shown. The description below thus also applies to the fastening of the filter module 9 to the mask body 2.

The inlet valve 6 encompasses a housing part 14, which encompasses a circular cylindrical base body 15 as well as a support element 16 in the shape of a ring disk 17 on the front side. For a better understanding, FIG. 4 shows a sectional illustration of the respirator mask 1 in the area of the filter module 8. With the circular cylindrical base body 15, the housing part 14 reaches through an opening 18 in the bottom 10. The diameter of the opening 18 thereby corresponds substantially to the outer diameter of the base body 15, so that the housing part 14 is supported radially in the opening 18, substantially without play. The housing part 14 itself is also embodied so as to be hollow and, at least in the area of the ring disk 17, encompasses a lattice structure 19, which supports a pin 20 in the center and which is arranged in a through-flow opening 21 of the housing part 14. The through-flow opening 21 is covered by means of a flexible valve element 22, which is embodied in a circular disk-shaped manner and which is held in the center on the housing part 14 by means of the pin 20. When the user inhales, the valve element 22 deforms inwardly due to the negative pressure in the interior of the mask body 2, so that air can flow from the outside to the inside. In the case of reversed pressure ratios, the valve element 22 seals the flow-through opening 21 or closes it, respectively.

The housing part 14 furthermore encompasses three rear grip elements 23, which are arranged so as to be evenly distributed across the circumference of the base body 15 and which protrude radially outwards. The rear grip elements 23 are thereby arranged at a distance to the ring disk 17. According to the number and arrangement of the accommodating elements 23, the edge of the opening 18 of the mask body 2 encompass radial recesses 24, through which the rear grip elements 23, together with the base body 15, can be guided through the opening 18.

On the side, which faces the mask body 2, the filter module 8 encompasses a filter module bottom 25, which is curved substantially in the same manner as the bottom 10 of the accommodating recess 11, so that, in the installed state, as is shown in particular in FIG. 4, there is always a space between the filter module bottom 25 and the bottom 10. Approximately in the center, a rear grip counter element 26, which is embodied as bayonet ring 27 and which is located at a distance to the filter module bottom 25, is furthermore arranged at the filter module bottom 25. For this purpose, the bayonet ring 25 encompasses a plurality of spacers 28, which are arranged so as to be distributed across the circumference and which, according to the instant exemplary embodiment, are embodied in one piece with the bayonet ring 27 and which are fixedly connected to the filter module bottom 25. Recesses 29, the function of which will be discussed below, are thus formed between the spacers 28. The bayonet ring 27 is embodied in a circular ring-shaped manner and encompasses radial recesses 30, which correspond to one another, according to the number and arrangement of the rear grip elements 23. The rear grip elements 23 are embodied such that they can engage behind the bayonet ring 27, when the housing part 14 is rotated accordingly relative to the filter module 8, as soon as the rear grip elements 23 have reached through the radial recesses 30.

For assembly purposes, the filter module 8 is thus (axially) inserted into the accommodating recess 11, wherein the outer contour of the filter module 8 corresponds to the contour of the side wall 13, so that the filter module 8 also encompasses a contour, which deviates from the circle. As soon as the filter module 8 has been partially inserted into the accommodating recess 11, an anti-rotation protection is formed by means of the contours of said accommodating recess, which prevents a rotation of the filter module 8 in the accommodating recess 11. The filter module 8 is inserted into the accommodating recess, in particular in the direction of the longitudinal axis of the housing part 14, until the rear grip elements 23 of the housing part 14 have passed through the radial recesses 30. The housing part 14 is then rotated, whereby the rear grip elements 23 engage behind the bayonet ring 27 axially—with regard to the longitudinal axis of the housing part 14. The filter module 8 and the housing part 14 are thus connected to one another axially in a form-locking manner.

As is shown in the instant exemplary embodiment, a sealing web 31, which is preferably embodied so as to be elastically deformable, also runs along the side edge 13 on the bottom 10. During assembly, the filter module bottom 25 is pressed against the sealing web 31, so that it is deformed elastically, in particular compressed, until the rear grip elements 23 can engage behind the bayonet ring 27. If the housing part 14 is then rotated, the spring tension stored in the sealing web 31 ensures that, on the one hand, the filter module 8 and the housing part 14 are held securely against one another and, on the other hand, that a closed chamber, which is defined laterally by the sealing web 31, is formed between the filter module bottom 25 and the bottom 10. As is illustrated in FIG. 4, provision is preferably made for a narrow recess 32, which extends parallel to the sealing web 31 across the entire course thereof, to be embodied between the sealing web 31 and the side wall 13. At its outer edge, the filter module bottom 25 encompasses a protrusion 33, which is also circumferential and which engages with this recess 32. The sealing effect of the sealing web 31 is improved once again through this.

In the area of the chamber, which is limited by the sealing web 31, the filter module bottom 25 encompasses a plurality of flow-through openings 34, only a few of which are provided with reference numerals herein for the sake of clarity. The filter module 8 encompasses a filter module housing 35, which encompasses the filter module bottom 25 and which is substantially cup shaped and in which a filter element 36 is arranged, which filters the ambient air on the way to the inlet valve 6. The filter element 36 can be produced in the known manner and will thus not he explained in more detail at this point. It is important for the filter element 36 to cover all of the flow-through openings 34, so that only filtered air reaches through the flow-through openings 34 into the chamber between filter module bottom 25 and bottom 10. From this chamber, the filtered air then reaches through the recesses 29 into the base body 15 of the housing part 14 and from there to the valve element 22, which deforms accordingly in response to a sufficient pressure difference—as explained above—so that the filtered air reaches into the interior of the mask body 2 and is available to the user for inhalation.

While—according to the instant exemplary embodiment—the accommodating recess 11 is embodied directly in the mask body 2, it can also be formed by means of a cup element 37—as suggested in FIG. 3. Said cup element then advantageously encompasses a higher stiffness than a remaining mask base body 38, so as to ensure the secure locking and fastening of the filter module 8 to the mask body 2. At the same time, a flexible embodiment of the mask base body 38 optimizes the wearing comfort of the respirator mask 1.

Due to the fact that the respective filter module 8, 9 is held in the corresponding accommodating recess 11 so as to be locked against rotation, and due to the fact that, by rotating the housing part at the mask body 2, it is fastened by means of the bayonet closure 39, which is formed by means of the housing part 14 and the bayonet ring 27, it is ensured that an inadvertent detachment of the respective filter module 8, 9 is prevented reliably in spite of the fastening by means of a bayonet closure 39, because the bayonet closure 39 can only be opened from the inside of the mask body 2. In addition, the described design of the respirator mask 1 makes it possible for the shaping of the filter modules 8, 9 not to be limited by the need to rotate or tilt the filter modules 8, 9 for the assembly thereof. The optical design of the respirator mask 1 can thus also be chosen much more freely than before.

We claim:

1. A respirator mask, comprising a mask body for covering mouth and nose of a user, comprising at least one exhalation valve arranged at the mask body, comprising at least one inhalation valve arranged at the mask body, and in each case comprising a filter module, which is assigned to the inhalation valve and which is/can be detachably fastened to the mask body, wherein the mask body encompasses an opening, through which a housing part of the inhalation valve reaches, wherein the housing part, together with the filter module, forms a detachable bayonet closure, characterized in that the housing part is rotatably supported in the opening of the mask body and that the opening is embodied in a bottom of an accommodating recess of the mask body, which encompasses a contour, which differs from a circle, for accommodating the filter module so as to be locked against rotation.

2. The respirator mask according to claim 1, characterized in that the housing part encompasses a circular cylindrical base body and, at a front side of the base body, at least one support element for resting against an inner side of the mask body.

3. The respirator mask according to claim 2, characterized in that support element is embodied as ring disk, the outer diameter of which is larger than the diameter of the opening.

4. The respirator mask according to claim 1, characterized in that the housing part encompasses a plurality of rear grip elements, which are arranged at an outer jacket wall of the base body and which protrude radially and which are embodied to interact with at least one rear grip counter element of the filter module for forming the bayonet closure.

5. The respirator mask according to claim 1, characterized in that the filter module encompasses a filter module housing, the outer contour of which corresponds at least substantially to the contour of the accommodating recess.

6. The respirator mask according to claim 4, characterized in that the filter module housing encompasses the at least one rear grip counter element, which is embodied as bayonet ring for accommodating the housing part of the inlet valve.

7. The respirator mask according to claim 6, characterized in that the bayonet ring is arranged at a filter module bottom of the filter module housing, which encompasses a plurality of through-flow openings.

8. The respirator mask according to claim 7, characterized in that the filter module bottom and/or the accommodating recess in each case encompass at least one sealing web, which runs at a distance to the bayonet closure in a frame-like manner.

9. The respirator mask according to claim 8, characterized in that the sealing web is embodied so as to be at least partially elastically deformable.

10. The respirator mask according to claim 8, characterized in that the flow-through openings in the filter module bottom are only embodied in an area, which is framed by the sealing web.

11. The respirator mask according to claim 1, characterized in that at least one recess is embodied between the bayonet ring and the filter module bottom.

12. The respirator mask according to claim 4, characterized in that the rear grip elements and/or the at least one rear grip counter element encompass at least one inclined surface, so as to effect that the filter module is pressed against the mask body in response to closing the bayonet closure.

13. The respirator mask according to claim 1, characterized in that the mask body is embodied in multiple parts, comprising a mask base body and comprising at least one cup element, which forms the respective accommodating recess, wherein the cup element in particular encompasses a higher stiffness than the mask base body.
